(19) United States
(12) Patent Application Publication
(10) Pub. No.: US 2014/0238129 A1
(43) Pub. Date: Aug. 28, 2014

(54) ANGULAR VELOCITY SENSOR AND DETECTION ELEMENT USED IN SAME

(71) Applicant: Panasonic Corporation, Osaka (JP)

(72) Inventor: Tsuyoshi Fujii, Osaka (JP)

(73) Assignee: Panasonic Corporation, Osaka (JP)

(21) Appl. No.: 14/352,637

(22) PCT Filed: Oct. 22, 2012
(86) PCT No.: PCT/JP2012/006732

§ 371 Date: Apr. 17, 2014

(30) Foreign Application Priority Data
Oct. 24, 2011 (JP) 2011-232427

(51) Int. Cl. G01P 3/14

(52) U.S. Cl. CPC G01P 3/14
USPC 73/504.12

(57) ABSTRACT

A detection element for detecting an angular velocity around at least one of X-, Y- and Z-axes orthogonal to one another, has a support, first to fourth vibration arms connected to the support at each first end, first to fourth weights connected to each second end of the respective vibration arms, and weight adjusting parts. Each vibration arm extends in a X-Y plane. The first and second vibration arms are, and the first and second weights are line-symmetrical with respect to the X-axis passing through the support. The first and third vibration arms are, the first and third weights are, the second and fourth vibration arms are, and the second and fourth weights are line-symmetrical with respect to the Y-axis passing through the support. The weight adjusting parts are provided only on diagonally positioned two of the first to fourth weights or the first to fourth vibration arms.

### TECHNICAL FIELD

The present invention relates to an angular velocity sensor used in mobile terminals, vehicles and the like, and a detection element used for the angular velocity sensor.

### BACKGROUND ART

FIG. 8 is a plan view of detection element 101 used for a conventional angular velocity sensor. Detection element 101 has support 102, vibration arms 103A to 103D, and weights 104A to 104D. Vibration arms 103A to 103D are connected to the side surfaces of support 102. Weights 104A to 104D are respectively connected to the other ends of vibration arms 103A to 103D. Vibration arms 103A to 103D are made, for example, of a piezoelectric material.

Drive parts, not shown in the Figure, are formed on vibration arms 103A to 103D. By applying an AC drive voltage to the drive parts, vibration arms 103A to 103D and weights 104A to 104D vibrate in the X-Y plane. When an angular velocity is applied around the X-axis or the Y-axis, a Coriolis force in the Z-axis direction perpendicular to the X-Y plane acts on detection element 101. The angular velocity can be detected based on a distortion of detection element 101 caused at this time. Also, when an angular velocity is applied around the Z-axis, a Coriolis force in a direction perpendicular to the vibration direction in the X-Y plane acts on detection element 101. The angular velocity can be detected based on a distortion of detection element 101 caused at this time. In this way, detection element 101 can detect angular velocities around orthogonal three axes with a single vibrator.

It is preferable for detecting the angular velocity around the Z-axis to mount detection electrodes 105 to 112 for detecting distortions on respective vibration arms 103A to 103D. However, as arms 103A to 103D cause their respective distortions during the drive vibration, not only the signals for detecting the angular velocity, but also undesired signals are generated at detection electrodes 105 to 112. To cancel these undesired signals, it is proposed to connect detection electrodes 105 to 112 to a signal processing circuit which gets a difference between signals in a proper combination (PTL 1, for example).

### CITATION LIST

### Patent Literature

PTL 1: Unexamined Japanese Patent Publication No. 2008-046058

### SUMMARY OF THE INVENTION

A detection element according to the present invention detects an angular velocity around at least one axis among an X-axis, a Y-axis and a Z-axis which are orthogonal to one another. This detection element has a support, first to fourth vibration parts, and weight adjusting parts. The first vibration part has a first vibration arm, and a first weight. The first vibration arm has a first end connected to the support, and a second end, and extends in a X-Y plane defined by the X-axis and the Y-axis. The first weight is connected to the second end of the first vibration arm. The second vibration part has a second vibration arm, and a second weight. The second vibration arm has a first end connected to the support, and a second end, and extends in the X-Y plane. The second vibration arm is line-symmetrical to the first vibration arm with respect to the X-axis passing through the support. The second weight is connected to the second end of the second vibration arm, and is line-symmetrical to the first weight with respect to the X-axis passing through the support. The third vibration part has a third vibration arm, and a third weight. The third vibration arm has a first end connected to the support, and a second end, and extends in the X-Y plane. The third vibration arm is line-symmetrical to the first vibration arm with respect to the Y-axis passing through the support. The third weight is connected to the second end of the third vibration arm, and is line-symmetrical to the first weight with respect to the Y-axis passing through the support. The fourth vibration part has a fourth vibration arm, and a fourth weight. The fourth vibration arm has a first end connected to the support, and a second end, and extends in the X-Y plane. The fourth vibration arm is line-symmetrical to the second vibration arm with respect to the Y-axis passing through the support. The fourth weight is connected to the second end of the fourth vibration arm, and is line-symmetrical to the second weight with respect to the Y-axis passing through the support. The weight adjusting parts are provided only on two vibration parts of either one pair of a pair of the first vibration part and the fourth vibration part and a pair of the second vibration part and the third vibration part. Also, an angular velocity sensor according to the present invention includes the above-described detection element, and a detection circuit which receives a signal outputted from a detection part of the detection element and processes the signal.

With this configuration, it is possible to suppress variations in the undesired signals caused by manufacturing variations, while suppressing vibrations generated at the detection element in directions out of the X-Y plane. As a result, the undesired signals can be cancelled without affecting the signals for detecting the angular velocity around the X-axis or around the Y-axis.

### BRIEF DESCRIPTION OF DRAWINGS

FIG. 1 is a block diagram showing a configuration for angular velocity detection, including an angular velocity sensor according to the present embodiment.

FIG. 2 is a plan view of a detection element of the angular velocity sensor shown in FIG. 1.

FIG. 3 is an explanatory diagram of drive vibration of the detection element shown in FIG. 2.

FIG. 4 is an explanatory diagram of detection vibration of the detection element shown in FIG. 2.

FIG. 5 is a chart showing polarities of the electric charges generated on detection electrodes of the detection element shown in FIG. 2 during drive vibration and detection vibration.

FIG. 6 is a displacement contour diagram during the drive vibration if weight adjusting parts are not provided diagonally on the detection element shown in FIG. 2.

FIG. 7 is a displacement contour diagram during the drive vibration when weight adjusting parts are provided diagonally on the detection element shown in FIG. 2.

FIG. 8 is a plan view of a detection element of a conventional angular velocity sensor.

### DESCRIPTION OF EMBODIMENTS

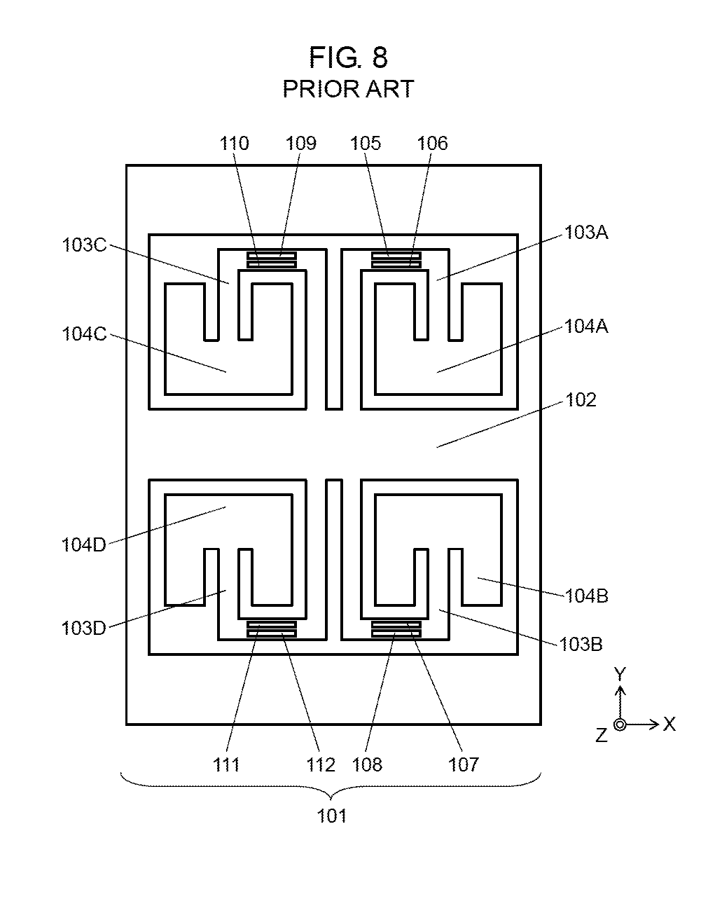

Prior to describing an embodiment of the present invention, problems of the conventional configuration shown in FIG. 8 are explained. The undesired signals caused by the drive vibration can be canceled by properly combining detection electrodes 105 to 112 for detecting the angular velocity around the Z-axis. However, the vibrators actually manufactured causes differences in vibration amplitudes during the drive vibration of four vibration arms 103A to 103D due to slight manufacturing variations. This causes variations of the undesired signals on detection electrodes 103A to 103D, so that the undesired signals cannot be canceled. Because of the undesired signals, the noises of the angular velocity detection signals vary among detection elements.

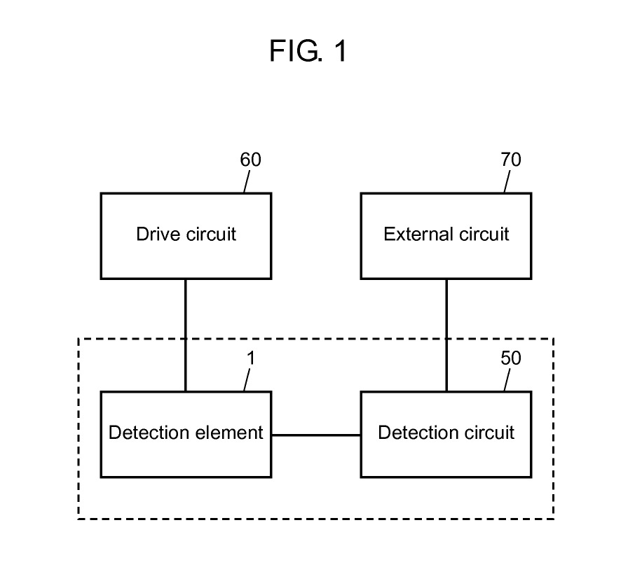

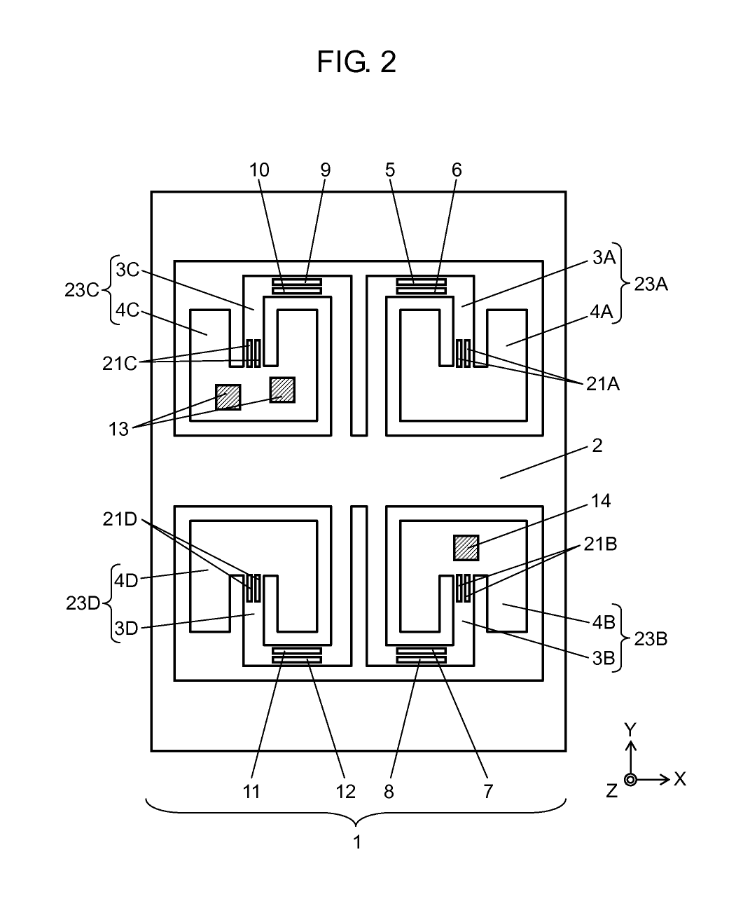

Hereinafter, an angular velocity sensor according to an embodiment of the present invention and a detection element used for this angular velocity sensor are described with reference to the drawings. FIG. 1 is a block diagram showing a configuration for angular velocity detection, including an angular velocity sensor according to the present embodiment. FIG. 2 is a plan view of a detection element of the angular velocity sensor according to the present embodiment.

In FIG. 1, detection circuit 50 and detection element 1 for detecting an angular velocity configure an angular velocity sensor. Detection circuit 50 receives and processes signals outputted from detection element 1. The signals processed by detection circuit 50 are outputted to external circuit 70. Drive circuit 60 supplies an AC voltage to detection element 1.

Detection element 1 shown in FIG. 2 detects angular velocities around an X-axis, a Y-axis and a Z-axis which are orthogonal to one another. Detection element 1 includes support 2, first vibration part 23A, second vibration part 23B, third vibration part 23C, fourth vibration part 23D, and weight adjusting parts 13 and 14.

First vibration part 23A has first vibration arm (arm, hereinafter) 3A, and first weight (weight, hereinafter) 4A. Arm 3A has a first end and a second end, where the first end is connected to support 2. Weight 4A is connected to the second end.

Similarly, second vibration part 23B has second vibration arm (arm, hereinafter) 3B, and second weight (weight, hereinafter) 4B. Arm 3B has a first end and a second end, where the first end is connected to support 2. Weight 4B is connected to the second end. Arm 3B is line-symmetrical to arm 3A with respect to the X-axis passing through support 2. Weight 4B is line-symmetrical to weight 4A with respect to this X-axis.

Third vibration part 23C has third vibration arm (arm, hereinafter) 3C, and third weight (weight, hereinafter) 4C. Arm 3C has a first end and a second end, where the first end is connected to support 2. Weight 4C is connected to the second end. Arm 3C is line-symmetrical to arm 3A with respect to the Y-axis passing through support 2. Weight 4C is line-symmetrical to weight 4A with respect to this Y-axis.

Fourth vibration part 23D has fourth vibration arm (arm, hereinafter) 3D, and fourth weight (weight, hereinafter) 4D. Arm 3D has a first end and a second end, where the first end is connected to support 2. Weight 4D is connected to the second end. Arm 3D is line-symmetrical to arm 3B with respect to the Y-axis passing through support 2. Weight 4D is line-symmetrical to weight 4B with respect to this Y-axis.

Each of arms 3A to 3D extends in an X-Y plane defined by the X-axis and the Y-axis. On respective arms 3A to 3D, detection electrodes 5 to 12 for detecting distortions are provided in order to detect an angular velocity around the Z-axis. Detection electrodes 5 to 12 are connected to detection circuit 50 shown in FIG. 1. Also on arms 3A to 3D, drive parts 21A to 21D for driving arms 3A to 3D are formed, respectively. Drive parts 21A to 21D are connected to drive circuit 60 shown in FIG. 1.

Weight adjusting parts 13 and 14 are provided only on two vibration parts of either one pair of the pair of first vibration part 23A and fourth vibration part 23D and the pair of second vibration part 23B and third vibration part 23C. In other words, weight adjusting parts 13 and 14 are provided only on two vibration parts positioned diagonally among first vibration part 23A to fourth vibration part 23D. In the embodiment shown in FIG. 2, weight adjusting parts 13 and 14 are provided only on weights 4B and 4C, respectively.

Hereinafter, each structural component is described. Support 2 is a fixed member for supporting detection element 1. Support 2 is fixed to a package (not shown) for housing detection element 1 with another support member or an adhesive.

Each of arms 3A to 3D has a nearly J-letter shape. Arms 3A to 3D are connected to side surfaces of support 2 with first ends thereof, respectively. Weights 4A to 4B are respectively connected to the second ends of arms 3A to 3D. Arms 3A to 3D and weights 4A to 4D can be driven to cause drive vibrations in the X-Y plane, and also can be deflected (bent) in the Z-axis direction.

Support 2, arms 3A to 3D and weights 4A to 4D may be made of a piezoelectric material such as crystal, LiTaO₃, LiNbO₃ and the like, or may be made of a non-piezoelectric material such as silicon, diamond, fused silica, alumina, GaAs and the like. Particularly, use of silicon makes it possible to produce a very small-sized element by using micro manufacturing technology, as well as to produce the element integrally with other integrated circuit components.

Support 2, arms 3A to 3D and weights 4A to 4D may be individually made of a same material or respective different materials, followed by being assembled to produce the detection element, or may alternatively be produced integrally by using a same material. In case of producing integrally by using a same material, support 2, arms 3A to 3D and weights 4A to 4D can be produced in a same process by using dry etching or wet etching. Therefore, detection element 1 can be produced efficiently.

As described above, drive parts 21A to 21D each composed of a piezoelectric element and drive electrodes are provided on arms 3A to 3D, respectively. When an AC drive voltage is applied to drive parts 21A to 21D, each of arms 3A to 3D and weights 4A to 4D causes a drive vibration in the X-Y plane. On the other hand, detection electrodes 5 to 12 for detecting an angular velocity are formed on detection parts made of piezoelectric elements provided on arms 3A to 3D. Detection electrodes 5 to 12 detect, as electric charges, distortions caused when an angular velocity is applied.

Weight adjusting parts 13 and 14 are provided only on weights 4B and 4C. Weight adjusting parts 13 are provided at two positions on weight 4C. In this way, the weight adjusting parts may be provided at plural positions on one weight. Weight adjusting parts 13 and 14 may be formed so as to reduce weight (heft) by removing a part of the weight with such a technique as laser trimming, for example, or so as to increase weight (heft) of the weight by such a technique as printing or mask vapor deposition. In other words, weight adjusting parts 13 and 14 are the traces after adjusting weight (heft) of each of weights 4B and 4C.

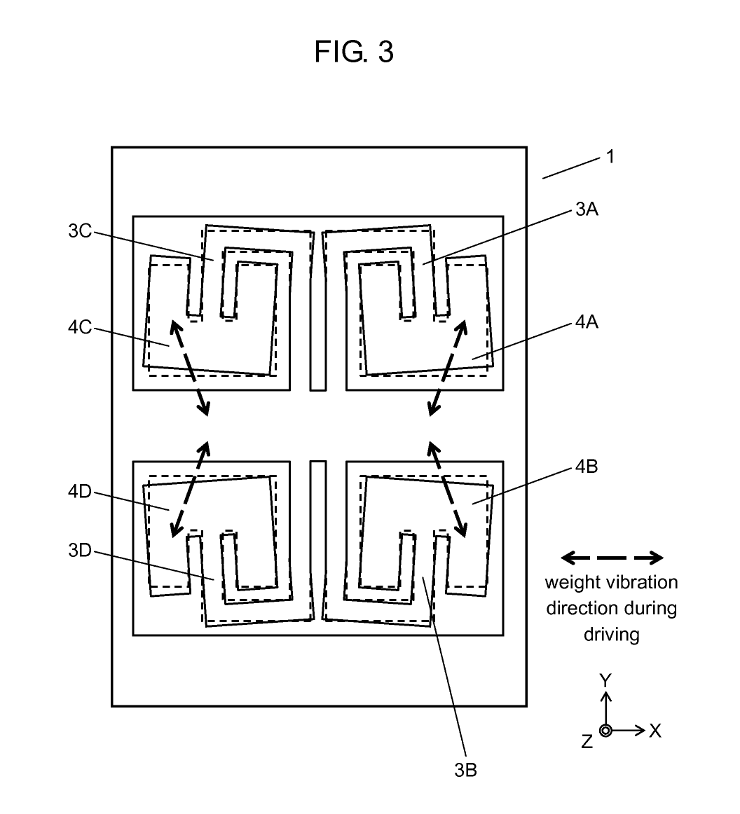

Next, the advantageous effects of the present embodiment are described, while describing the principle of the angular velocity sensor. When an AC voltage is applied from external drive circuit 60 to drive parts 21A to 21D made of piezoelectric elements on the arms, arms 3A to 3D and weights 4A to 4D vibrate in the weight vibration direction during driving on the X-Y plane as shown in FIG. 3.

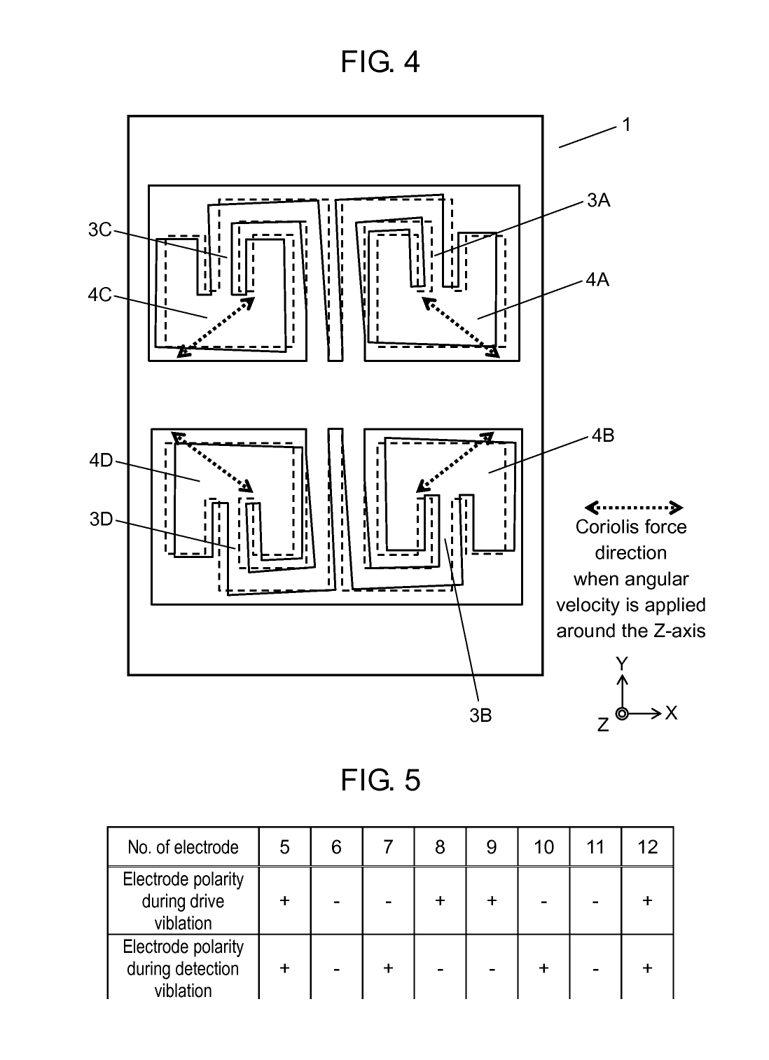

When an angular velocity is applied around the Z-axis at this time, a Coriolis force acting on each of weights 4A to 4D is generated in a direction perpendicular to the weight vibration direction during driving on the X-Y plane as shown in FIG. 4. This direction in which the Coriolis force is generated will hereinafter be referred to as Coriolis force direction Z. The generated Coriolis force excites a detection vibration in Coriolis force direction Z. Detection electrodes 5 to 12 detect distortions of arms 3A to 3D caused by this Coriolis force. In this way, the angular velocity around the Z-axis can be detected.

However, detection electrodes 5 to 12 detect distortions of arms 3A to 3D continuously during the drive vibration. The signals detected except for the angular velocity detection will hereinafter be referred to as “undesired signals”. The undesired signals are much larger than the signals for detecting the angular velocity. Thus, the undesired signals become noises when angular velocity detection output signals are amplified in the external circuit.

The electric charges generated in detection electrodes 5 to 12 during the drive vibration and during the detection vibration when an angular velocity is applied around the Z-axis show polarities as shown in FIG. 5 depending on the differences whether the forces acting on the respective piezoelectric elements are in the compressing direction or in the tensile direction. Here, the signal outputted from each of detection electrodes 5 to 12 when an angular velocity is applied to the Z-axis is calculated by using mathematical formula (1). Accordingly, the positive electric charges and the negative electric charges are canceled each other during the drive vibration so that the undesired signals are canceled out. During the detection vibration, on the other hand, differences between the positive electric charges and the negative electric charges are taken, so that the signal due to detection of the angular velocity can be detected. Here, (Electrode X) denotes the quantity of electric charge outputted from a corresponding detection electrode X.

{(Electrode 5)+(Electrode 7)+(Electrode 10)+(Electrode 12)}−{(Electrode 6)+(Electrode 8)+(Electrode 9)+(Electrode 11)} (1)

If arms 3A to 3D and weights 4A to 4D are such an ideal condition that they vibrate with completely the same amplitude during the drive vibration, the electric charges generated at each of detection electrodes 5 to 12 for detecting the distortions become the same in quantity, so that the same quantity of electric charges of the opposite polarities will be canceled each other. However, when slight variations in the machined shapes of the arms or weights occur, variations in vibration quantities of the arms and weights will be caused. Accordingly, the quantity of electric charges generated on detection electrodes 5 to 12 also vary. As a result, the undesired signals cannot be canceled by the process of taking the differences. When a detection element is actually produced and the undesired signals are evaluated according to mathematical formula (1), the undesired signals are not completely canceled, but variations are caused from one detection element to another.

To reduce the variations in the undesired signals caused by the manufacturing variations, the present embodiment is provided with weight adjusting parts 13 and 14. By reducing some weight (heft) from the weights at weight adjusting parts 13 and 14, the vibration quantities of the arms and weights can be forcibly increased. Alternatively, the vibration quantities can be decreased by adding some weight (heft) to the weights. As a result, the variations in the vibration quantities among the arms and weights can be reduced, so that the variations in the undesired signals can be suppressed.

It may be possible to produce a detection element, measure the actual amounts of the undesired signals, and then determine the weight adjusting amounts according to the measured values. That is, even if a detection element generates the undesired signals caused due to manufacturing variations, it is possible to forcibly make the vibration quantities of the arms 3A to 3D of the detection element to be the same during the drive vibration by providing weight adjusting parts 13 and 14, thereby to cancel out the undesired signals. Also, if the amounts of the undesired signals can be predicted in advance, the weight adjustment may be performed at the stage of producing the detection element according to the predicted values.

The weight adjusting parts may not necessarily be provided at diagonal positions as far as they may only adjust the undesired signals. However, it is possible to suppress vibrations in directions out of the X-Y plane by providing the weight adjusting parts at diagonal positions. This will be described based on a result of simulation analysis by finite element method.

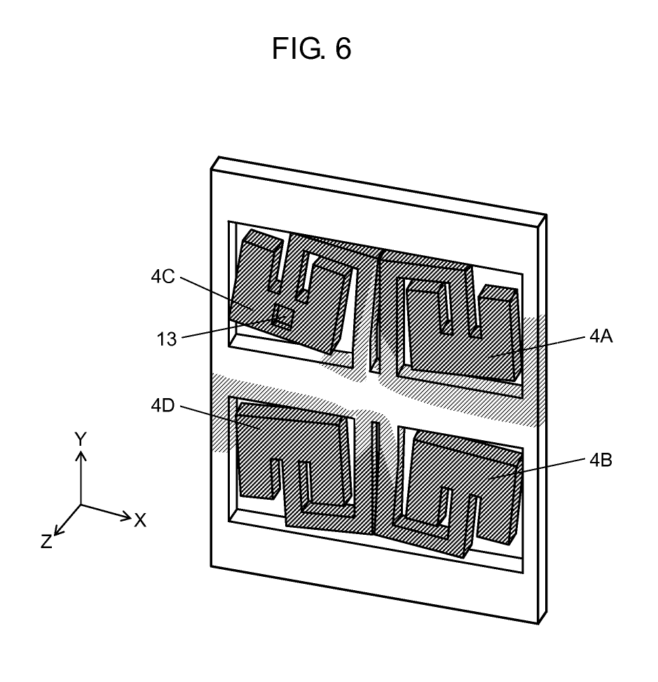

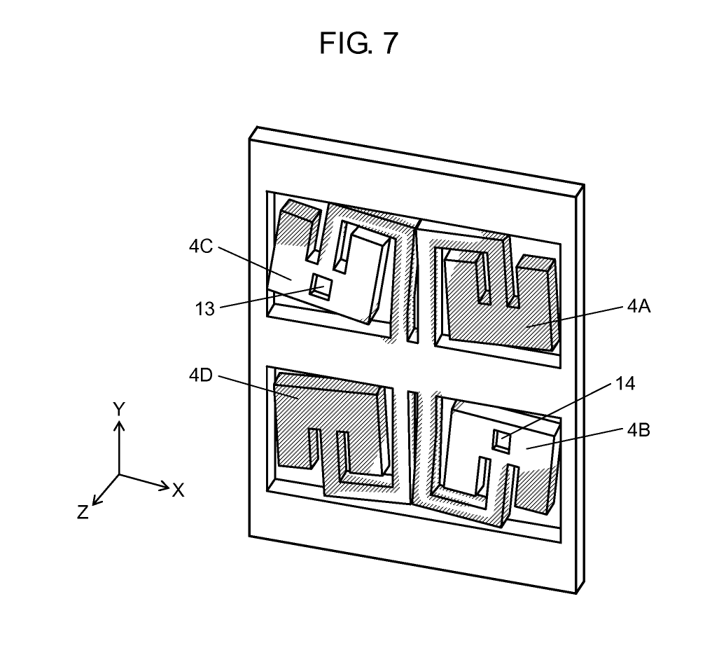

FIG. 6 and FIG. 7 are contour diagrams of the displacement in detection element 1 along the Z-axis direction during the drive vibration. In FIGS. 6 and 7, larger displaced portions are indicated by higher density hatchings. In FIG. 6, only weight adjusting part 13 on weight 4C is provided by removing a part of weight 4C. That is, only weight 4C is made lighter among weights 4A to 4D. Accordingly, arms 3A to 3D and weights 4A to 4D cannot be balanced by only the vibrations on the X-Y plane, so that weight 4A to 4D are vibrating largely in the Z-axis direction. These movements of weights 4A to 4D in the Z-axis direction become a major cause of the undesired signals during detecting an angular velocity around the X-axis or around the Y-axis in detection element 1, and thus are not desirable as a multi-axial angular velocity sensor similarly to the undesired signals around the Z-axis.

On the other hand, when weight adjusting parts 13 and 14 are provided on diagonally positioned weights 4B and 4C, respectively, weights 4B and 4C balance each other. Also, weights 4A and 4D, which are not adjusted in weight, also balance each other. As a result, it is possible to largely suppress the movements of the weights in the Z-axis direction. Accordingly, it is possible to suppress the influences on the undesired signals during detecting the angular velocity around the X-axis or around the Y-axis.

Since weights 4A to 4D have relatively large areas, it is easy to provide weight adjusting parts 13 and 14 on them. Further, any drive parts and detection parts made of piezoelectric elements are not provided on weights 4A to 4D. Therefore, in the foregoing description, weight adjusting parts 13 and 14 are provided on weights 4A to 4D. However, the weight adjusting parts may be provided only on diagonally positioned arms 3A and 3D or only on diagonally positioned arms 3B and 3C. In the cases also, the above-described effects can be obtained. In other words, the weight adjusting parts may be provided only on two vibration parts of either one pair of the pair of first vibration part 23A and fourth vibration part 23D and the pair of second vibration part 23B and third vibration part 23C.

In this manner, detection element 1 balance the vibrations of weights 4A to 4D by providing weight adjusting parts 13 and 14 on diagonally positioned two vibration parts. For this reason, it is preferable to dispose weight adjusting parts 13 and 14 so as to be point-symmetrical with respect to a center of gravity of the entire element including arms 3A to 3D and weights 4A to 4D. That is, it is preferable that weight adjusting parts 13 and 14 are disposed point-symmetrically with respect to the center of gravity of detection element 1. With this arrangement, the motions of the weights in the Z-axis direction can be most effectively suppressed.

As described above, it is possible, in an angular velocity sensor, to cancel the undesired signals during detecting the angular velocity around the Z-axis, while suppressing the undesired signals during detecting angular velocities in the X-axis direction and the Y-axis direction. Accordingly, variations in noises of an angular velocity sensor can be reduced.

In the description hereinabove, detection element 1 detects angular velocities around the X-axis, the Y-axis and the Z-axis which are orthogonal to one another. However, it is not always necessary to detect all of the angular velocities around the X-axis, the Y-axis and the Z-axis. The configuration according to the present embodiment is effective also in the case of detecting an angular velocity around any one or angular velocities around any two of the X-axis, the Y-axis and the Z-axes.

### INDUSTRIAL APPLICABILITY

The angular velocity sensor according to the present invention, which can suppress the variations in noises of the angular velocity outputs, can be applied to the uses including from image stabilization for cameras to vehicle controls.

### REFERENCE MARKS IN THE DRAWINGS

1 detection element
2 support
3A first vibration arm (arm)
3B second vibration arm (arm)
3C third vibration arm (arm)
3D fourth vibration arm (arm)
4A first weight (weight)
4B second weight (weight)
4C third weight (weight)
4D fourth weight (weight)
5, 6, 7, 8, 9, 10, 11, 12 detection electrode
13, 14 weight adjusting part
21A, 21B, 21C, 21D drive part
23A first vibration part
23B second vibration part
23C third vibration part
23D fourth vibration part
50 detection circuit
60 drive circuit
70 external circuit

1. A detection element configured to detect an angular velocity around at least one axis among an X-axis, a Y-axis and a Z-axis which are orthogonal to one another, the detection element comprising:
a support;
a first vibration part having a first vibration arm which has a first end connected to the support and a second end, and extends in a X-Y plane defined by the X-axis and the Y-axis, and a first weight which is connected to the second end of the first vibration arm;
a second vibration part having a second vibration arm which has a first end connected to the support, and a second end, extends in the X-Y plane, and is line-symmetrical to the first vibration arm with respect to the X-axis passing through the support, and a second weight which is connected to the second end of the second vibration arm, and is line-symmetrical to the first weight with respect to the X-axis passing through the support;
a third vibration part having a third vibration arm which has a first end connected to the support, and a second end, extends in the X-Y plane, and is line-symmetrical to the first vibration arm with respect to the Y-axis passing through the support, and a third weight which is connected to the second end of the third vibration arm, and is line-symmetrical to the first weight with respect to the Y-axis passing through the support;
a fourth vibration part having a fourth vibration arm which has a first end connected to the support, and a second end, extends in the X-Y plane, and is line-symmetrical to the second vibration arm with respect to the Y-axis passing through the support, and a fourth weight which is connected to the second end of the fourth vibration arm, and is line-symmetrical to the second weight with respect to the Y-axis passing through the support; and
weight adjusting parts provided only on two vibration parts of either one pair of a pair of the first vibration part and the fourth vibration part and a pair of the second vibration part and the third vibration part.

2. The detection element according to claim 1,
wherein the weight adjusting parts are provided only on two weights of either one pair of a pair of the first weight and the fourth weight and a pair of the second weight and the third weight.

3. The detection element according to claim 1,
wherein the weight adjusting parts are provided only on two vibration arms of either one pair of a pair of the first vibration arm and the fourth vibration arm and a pair of the second vibration arm and the third vibration arm.

4. The detection element according to claim 1,
wherein the weight adjusting parts are disposed point-symmetrically with respect to a center of gravity of the detection element.

5. An angular velocity sensor comprising:
a detection element according to claim 1; and
a detection circuit configured to receive a signal outputted from a detection part of the detection element, and process the signal.
